(19) United States
(12) Patent Application Publication
(10) Pub. No.: US 2023/0108014 A1
(43) Pub. Date: Apr. 6, 2023

(54) TRANSFER FILM, METHOD FOR PRODUCING TRANSFER FILM, POLARIZING PLATE, AND IMAGE DISPLAY APPARATUS

(71) Applicant: FUJIFILM Corporation, Tokyo (JP)

(72) Inventors: Yoshinori MAEDA, Kanagawa (JP); Yuta TAKAHASHI, Kanagawa (JP)

(73) Assignee: FUJIFILM Corporation, Tokyo (JP)

(21) Appl. No.: 17/952,960

(22) Filed: Sep. 26, 2022

(30) Foreign Application Priority Data
Sep. 29, 2021 (JP) 2021-159871

(51) Int. Cl. G02B 5/30; C08F 220/32; C09K 19/20

(52) U.S. Cl. CPC G02B 5/3016; C08F 220/325; C09K 19/2007; B29C 41/02

(57) ABSTRACT

A transfer film in an image display apparatus includes a temporary support including a substrate and an optically anisotropic layer, in which an in-plane retardation of the substrate at a wavelength of 550 nm is 0 to 20 nm, the optically anisotropic layer is formed of a liquid crystal compound, and where the optically anisotropic layer obtained by peeling the temporary support from the transfer film is allowed to stand in a predetermined environment, and then a maximum value of a dimensional change rate in an in-plane direction of the optically anisotropic layer is defined as ΔL (max) and a minimum value of the dimensional change rate is defined as ΔL (min), the transfer film satisfies at least one of Expression (1) ΔL (max)/ΔL (min)≤1.5 or Expression (2) ΔL (max)≤0.08%.

### CROSS-REFERENCE TO RELATED APPLICATIONS

The present application claims priority under 35 U.S.C. § 119 to Japanese Patent Application No. 2021-159871, filed on Sep. 29, 2021. The above application is hereby expressly incorporated by reference, in its entirety, into the present application.

### BACKGROUND OF THE INVENTION

### 1. Field of the Invention

The present invention relates to a transfer film, a method for producing a transfer film, a polarizing plate, and an image display apparatus.

### 2. Description of the Related Art

An optically anisotropic layer having refractive index anisotropy is applied to various applications such as an antireflection film of an image display apparatus and an optical compensation film of a liquid crystal display device.

For example, JP2019-168692A discloses an image display apparatus including an optically anisotropic layer (phase difference layer). In particular, a transfer film including an optically anisotropic layer provided on a releasable support substrate is used in JP2019-168692A.

### SUMMARY OF THE INVENTION

In a case where a transfer film including an optically anisotropic layer as described in JP2019-168692A is used, the transfer film is often applied to various productions after confirming that the transfer film has no optical defects.

In a case where an image display apparatus is produced using the transfer film described in JP2019-168692A, the present inventors have found that many defects are confirmed in a case where the obtained image display apparatus is observed under external light, and further improvement is required.

The present invention has been made in view of the above circumstances, and an object of the present invention is to provide a transfer film having few defects in a case of being observed under external light, in an image display apparatus used for transferring an optically anisotropic layer and produced by a method including a step of transferring the optically anisotropic layer.

Another object of the present invention is to provide a method for producing a transfer film, a polarizing plate, and an image display apparatus.

As a result of extensive studies on the problems of the related art, the present inventors have found that the foregoing objects can be achieved by the following configurations.

(1) A transfer film including a temporary support including a substrate and an optically anisotropic layer disposed on the temporary support, in which an in-plane retardation of the substrate at a wavelength of 550 nm is 0 to 20 nm, the optically anisotropic layer is a layer formed of a liquid crystal compound, and in a case where the optically anisotropic layer obtained by peeling the temporary support from the transfer film is allowed to stand for 8 days in an environment with a temperature of 25° C. and a relative humidity of 60%, and then a maximum value of a dimensional change rate in an in-plane direction of the optically anisotropic layer is defined as ΔL (max) and a minimum value of the dimensional change rate is defined as ΔL (min), the transfer film satisfies at least one of Expression (1) or Expression (2) which will be described later.

(2) The transfer film according to (1), in which the temporary support further includes an alignment film.

(3) The transfer film according to (1) or (2), in which the optically anisotropic layer is a layer formed by fixing a liquid crystal compound twist-aligned along a helical axis extending in a thickness direction, or a layer formed by fixing a liquid crystal compound aligned homogeneously.

(4) The transfer film according to any one of (1) to (3), in which the optically anisotropic layer is a layer formed by fixing a liquid crystal compound twist-aligned along a helical axis extending in a thickness direction, and a twisted angle of the liquid crystal compound is 15° to 140°.

(5) The transfer film according to (4), in which the twisted angle of the liquid crystal compound is 60° to 91°.

(6) A method for producing a transfer film including a temporary support including a substrate and an optically anisotropic layer, the method including a step 1 of applying a liquid crystal composition containing a liquid crystal compound having a polymerizable group onto the temporary support to form a coating film, aligning the liquid crystal compound in the coating film, and subjecting the coating film to a curing treatment to form the optically anisotropic layer, in which, in a case where the optically anisotropic layer obtained by peeling the temporary support from the transfer film is allowed to stand for 8 days in an environment with a temperature of 25° C. and a relative humidity of 60%, and then a direction in which a dimensional change rate in an in-plane direction of the optically anisotropic layer is the largest is defined as a direction X, a dimensional change rate X of the temporary support in the direction X calculated by a method X which will be described later for the temporary support in the transfer film is −0.25% or less.

(7) A method for producing a transfer film, including a step 1 of applying a liquid crystal composition containing a liquid crystal compound having a polymerizable group onto a temporary support including a substrate to form a coating film, aligning the liquid crystal compound in the coating film, and subjecting the coating film to a curing treatment to form an optically anisotropic layer, and a step 2 of bringing the optically anisotropic layer into contact with superheated steam after the step 1.

(8) A polarizing plate including the optically anisotropic layer obtained by peeling the temporary support from the transfer film according to any one of (1) to (5) and a polarizer.

(9) The polarizing plate according to (8), in which another optically anisotropic layer different from the optically anisotropic layer is further included between the optically anisotropic layer and the polarizer, the optically anisotropic layer is a layer formed by fixing a liquid crystal compound twist-aligned along a helical axis extending in a thickness direction, a twisted angle of the liquid crystal compound is 60° to 91°, a product Δnd of a refractive index anisotropy Δn of the optically anisotropic layer at a wavelength of 550 nm and a thickness d of the optically anisotropic layer is 142 to 202 nm, and an in-plane retardation of the other optically anisotropic layer at a wavelength of 550 nm is 142 to 202 nm.

(10) An image display apparatus including the polarizing plate according to (8) or (9).

According to an aspect of the present invention, it is possible to provide a transfer film having few defects in a case of being observed under external light, in an image display apparatus used for transferring an optically anisotropic layer and produced by a method including a step of transferring the optically anisotropic layer.

According to another aspect of the present invention, it is also possible to provide a method for producing a transfer film, a polarizing plate, and an image display apparatus.

### DESCRIPTION OF THE PREFERRED EMBODIMENTS

Hereinafter, the present invention will be described in more detail.

Any numerical range expressed using “to” in the present specification refers to a range including the numerical values before and after the “to” as a lower limit value and an upper limit value, respectively.

In addition, the in-plane slow axis and the in-plane fast axis are defined at a wavelength of 550 nm unless otherwise specified. That is, unless otherwise specified, for example, the in-plane slow axis direction means a direction of the in-plane slow axis at a wavelength of 550 nm.

In the present invention, Re(λ) and Rth(λ) represent an in-plane retardation at a wavelength λ and a thickness direction retardation at a wavelength λ, respectively. Unless otherwise specified, the wavelength λ is 550 nm.

In the present invention, Re(λ) and Rth(λ) are values measured at a wavelength λ in AxoScan OPMF-1 (manufactured by Opto Science, Inc.). By inputting an average refractive index ((nx+ny+nz)/3) and a film thickness (d(μm)) in AxoScan,

In-plane slow axis direction (°)

Re(λ)=R0(λ)

Rth(λ)=((nx+ny)/2−nz)×d

are calculated.

Although R0(λ) is displayed as a numerical value calculated by AxoScan OPMF-1, it means Re(λ).

In the present specification, the refractive indexes nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with an interference filter.

In addition, the values in Polymer Handbook (John Wiley & Sons, Inc.) and catalogs of various optical films can be used. The values of the average refractive index of main optical films are illustrated below: cellulose acylate (1.48), cycloolefin polymer (1.52), polycarbonate (1.59), polymethylmethacrylate (1.49), and polystyrene (1.59).

In the present specification, the “visible ray” is intended to refer to light having a wavelength of 400 to 700 nm. In addition, the “ultraviolet ray” is intended to refer to light having a wavelength of 10 nm or more and less than 400 nm.

In addition, in the present specification, the relationship of angles including “orthogonal” and “parallel” is intended to include a range of errors acceptable in the art to which the present invention pertains. For example, it means that an angle is within an error range of ±5° with respect to the exact angle, and the error with respect to the exact angle is preferably within a range of ±30.

The feature points of the transfer film according to the embodiment of the present invention are that an in-plane retardation of a substrate included in a temporary support at a wavelength of 550 nm is adjusted, and that an optically anisotropic layer exhibiting predetermined characteristics is used.

As described above, in a case where a transfer film including an optically anisotropic layer is used, the transfer film is often applied to various productions after confirming that the transfer film has no defects. That is, the transfer film determined to be free of defects by the defect inspection is used in the production of an image display apparatus.

On the other hand, the present inventors have found that, in a case where the in-plane retardation of the substrate in the temporary support included in the transfer film is equal to or more than a predetermined value, a defect inspection device cannot accurately inspect the presence or absence of defects, and a transfer film containing defects that should not be used essentially in the production is used in the production of an image display apparatus, resulting in obtaining the image display apparatus in which the defects are observed in a case of being observed under external light.

Therefore, it has been found that, by setting the in-plane retardation of the substrate in the temporary support within a range of a predetermined value, the presence or absence of defects can be determined more accurately by the defect inspection device in advance, and as a result, an image display apparatus having few defects in a case of being observed under external light can be obtained.

In addition, in a case where the present inventors investigated the cause of the problem to be solved by the present invention, it has been found that the defects in the optically anisotropic layer contained in the transfer film had an effect. Furthermore, the cause of defects in the optically anisotropic layer contained in the transfer film was investigated. In a case where there was dust or the like between the temporary support and the optically anisotropic layer upon preparing the optically anisotropic layer, wrinkles were likely to occur in the optically anisotropic layer in the vicinity thereof, and as a result, defects derived from wrinkles having a size larger than the size of the dust were generated. In consideration of the above mechanism, the present inventors have found that the wrinkles are less likely to occur by using an optically anisotropic layer satisfying at least one of Expression (1) or Expression (2) which will be described later, and as a result, a desired image display apparatus can be obtained. Although the detailed reason why the wrinkles are less likely to occur by using an optically anisotropic layer satisfying at least one of Expression (1) or Expression (2) is unknown, it is considered that wrinkles caused by dust or the like are less likely to occur in a case where the dimensional change rate is small as represented by Expression (1) or in a case where the anisotropy of the dimensional change rate is small as represented by Expression (2).

Hereinafter, each of members included in the transfer film will be described in detail.

Temporary Support

The transfer film according to the embodiment of the present invention includes a temporary support.

The temporary support includes a substrate having an in-plane retardation of 0 to 20 nm at a wavelength of 550 nm.

The in-plane retardation of the substrate at a wavelength of 550 nm may be 0 to 20 nm. From the viewpoint that an image display apparatus having fewer defects during image display can be obtained (hereinafter, also simply referred to as “the viewpoint that the effect of the present invention is more excellent”), the in-plane retardation of the substrate at a wavelength of 550 nm is preferably 0 to 10 nm and more preferably 0 to 5 nm.

The thickness direction retardation of the substrate at a wavelength of 550 nm is not particularly limited, and is preferably 0 to 100 nm and more preferably 0 to 50 nm from the viewpoint that the visibility does not change in a case where the planar inspection is carried out from an oblique direction.

The material constituting the substrate is not particularly limited, and examples thereof include a polyester-based resin, a cellulose-based resin, a (meth)acrylic resin, a polycarbonate-based resin, a styrene-based resin, a polyolefin-based resin, a vinyl chloride-based resin, and an amide-based resin.

The (meth)acrylic resin is a general term for an acrylic resin and a methacrylic resin.

The thickness of the substrate is not particularly limited, and is preferably 10 to 200 μm and more preferably 20 to 150 μm from the viewpoint of excellent handleability.

The temporary support may be composed of only the substrate, or may include another member other than the substrate.

The in-plane retardation of the other member at a wavelength of 550 nm is preferably 0 to 10 nm and more preferably 0 to 5 nm.

Examples of the other member include an alignment film.

The alignment film can be formed by means such as rubbing treatment of an organic compound (preferably a polymer), oblique vapor deposition of an inorganic compound, formation of a layer having microgrooves, or accumulation of an organic compound (for example, ω-tricosanoic acid, dioctadecylmethylammonium chloride, or methyl stearate) by the Langmuir-Blodgett method (LB film).

In addition, examples of the alignment film include a photo-alignment film. The photo-alignment film is an alignment film formed by irradiating a photo-alignable material with light (exposing a photo-alignable material to light). The photo-alignment material is not particularly limited, and examples thereof include a cinnamate compound, a chalcone compound, and a coumarin compound.

Above all, the photo-alignment film is preferable from the viewpoint that the effect of the present invention is more excellent.

The thickness of the alignment film is not particularly limited as long as it can exhibit the alignment function, and is preferably 0.01 to 5.0 μm and more preferably 0.05 to 2.0 μm.

The thickness of the entire temporary support is not particularly limited, and is preferably 10 to 200 μm and more preferably 20 to 150 μm from the viewpoint of excellent handleability.

The dimensional stability of the temporary support is not particularly limited, and as will be described in detail later, it is preferable that the temporary support exhibits a predetermined dimensional change rate X.

Optically Anisotropic Layer

The transfer film includes an optically anisotropic layer. The optically anisotropic layer is peelably disposed on the temporary support.

The optically anisotropic layer is a layer formed of a liquid crystal compound.

Above all, as will be described later, the optically anisotropic layer is preferably a layer formed by fixing a liquid crystal compound and more preferably a layer formed by fixing a liquid crystal compound having a polymerizable group by polymerization.

In the present specification, the “fixed” state is a state in which the alignment of a liquid crystal compound is maintained. Specifically, the “fixed” state is preferably a state in which, in a temperature range of usually 0° C. to 50° C. or in a temperature range of −30° C. to 70° C. under more severe conditions, the layer has no fluidity and a fixed alignment morphology can be maintained stably without causing a change in the alignment morphology due to an external field or an external force.

The type of the liquid crystal compound is not particularly limited, and examples thereof include a compound capable of either homeotropic alignment, homogenous alignment, hybrid alignment, or cholesteric alignment.

Here, in general, the liquid crystal compound can be classified into a rod-like liquid crystal compound and a disk-like liquid crystal compound according to its shape. Furthermore, there are a low molecular weight type and a high molecular weight type, respectively. The high molecular weight generally refers to having a polymerization degree of 100 or more (Polymer Physics-Phase Transition Dynamics, Masao Doi, p. 2, Iwanami Shoten Publishers, 1992). Any liquid crystal compound can be used in the present invention, and a rod-like liquid crystal compound or a discotic liquid crystal compound (disk-like liquid crystal compound) is preferable. In addition, a relatively low molecular weight liquid crystal compound which is a monomer or has a polymerization degree of less than 100 is preferable.

The liquid crystal compound preferably has a polymerizable group. That is, the liquid crystal compound is preferably a polymerizable liquid crystal compound. Examples of the polymerizable group contained in the polymerizable liquid crystal compound include an acryloyl group, a methacryloyl group, an epoxy group, and a vinyl group.

Polymerizing such a polymerizable liquid crystal compound makes it possible to fix the alignment of the liquid crystal compound. After the liquid crystal compound is fixed by polymerization, it is no longer necessary to exhibit liquid crystallinity.

For example, those described in claim 1 of JP1999-513019A (JP-H11-513019A) or paragraphs [0026] to [0098] of JP2005-289980A are preferable as the rod-like liquid crystal compound. For example, those described in paragraphs [0020] to [0067] of JP2007-108732A or paragraphs [0013] to [0108] of JP2010-244038A are preferable as the discotic liquid crystal compound.

In addition, a liquid crystal compound having a reverse wavelength dispersibility may be used as the liquid crystal compound.

The transfer film according to the embodiment of the present invention satisfies at least one of Expression (1) or Expression (2) in a case where the optically anisotropic layer obtained by peeling the temporary support from the transfer film is allowed to stand for 8 days in an environment with a temperature of 25° C. and a relative humidity of 60%, and then a maximum value of a dimensional change rate in an in-plane direction of the optically anisotropic layer is defined as ΔL (max) and a minimum value of the dimensional change rate is defined as ΔL (min).

ΔL(max)/ΔL(min)≤1.5 Expression (1)

ΔL(max)≤0.08% Expression (2)

Hereinafter, the requirements of Expression (1) and Expression (2) will be described in detail.

As a method for calculating ΔL (max) and ΔL (min), first, a measurement sample having a length of 15 cm and a width of 15 cm is cut out from the transfer film. Next, the cut out measurement sample is allowed to stand for 2 hours in an environment with a temperature of 25° C. and a relative humidity of 60%. Then, a total of 36 straight lines with a length of 10 cm are drawn on the surface of the optically anisotropic layer of the measurement sample by tilting the sample by 5 degrees. The length of the straight line is measured by QVA606-PRO-AEL10 (manufactured by Mitutoyo Corporation).

Next, the optically anisotropic layer obtained by peeling the temporary support from the measurement sample is allowed to stand for 8 days in an environment with a temperature of 25° C. and a relative humidity of 60%, and then the lengths of 36 straight lines drawn on the surface of the optically anisotropic layer are measured using the above apparatus in an environment with a temperature of 25° C. and a relative humidity of 60%. ΔL (max) (%) is calculated according to Expression A using a length L max (cm) of the straight line having the largest change from an initial value (10 cm) among the measured values of the 36 straight lines.

ΔL(max)={(absolute value of difference between L max and 10 cm)/10}×100 Expression A

Next, ΔL (min) (%) is calculated according to Expression B using a length L min (cm) of the straight line having the smallest change from the initial value (10 cm) among the measured values of the 36 straight lines.

ΔL(min)={(absolute value of difference between L min and 10 cm)/10}×100 Expression B

The requirement of Expression (1) means that a ratio of ΔL (max) to ΔL (min) (ΔL (max)/ΔL (min)) is 1.5 or less.

The ratio (ΔL (max)/ΔL (min)) is preferably 1.2 or less and more preferably 1.1 or less from the viewpoint that the effect of the present invention is more excellent. The lower limit of the ratio (ΔL (max)/ΔL (min)) is not particularly limited, and may be, for example, 1.0.

In a case where the requirement of Expression (1) is satisfied, the range of the value of ΔL (max) is not particularly limited, and is preferably 0.50% or less, more preferably 0.28% or less, and still more preferably 0.20% or less from the viewpoint that the effect of the present invention is more excellent. The lower limit of ΔL (max) is not particularly limited, and may be, for example, 0%.

The requirement of Expression (2) means that ΔL (max) is 0.08% or less.

In a case where the requirement of Expression (2) is satisfied, ΔL (max) is preferably 0.05% or less and more preferably 0.03% or less from the viewpoint that the effect of the present invention is more excellent. The lower limit of ΔL (max) is not particularly limited, and may be, for example, 0%.

The type of the optically anisotropic layer exhibiting the above-mentioned characteristics is not particularly limited, and examples thereof include a layer formed by fixing a liquid crystal compound twist-aligned along a helical axis extending in a thickness direction, which will be described later. In addition to the above aspect, examples of the optically anisotropic layer exhibiting the above-mentioned characteristics include an optically anisotropic layer subjected to a superheated steam treatment which will be described later, and an optically anisotropic layer formed by using a temporary support exhibiting a predetermined dimensional change rate.

From the viewpoint that the effect of the present invention is more excellent, the optically anisotropic layer is preferably a layer formed by fixing a liquid crystal compound twist-aligned along a helical axis extending in a thickness direction, or a layer formed by fixing a liquid crystal compound aligned homogeneously.

The “liquid crystal compound is twist-aligned” is intended to mean that the liquid crystal compound from one main surface to the other main surface of the optically anisotropic layer is twisted about the thickness direction of the optically anisotropic layer. Along with this, the alignment direction (in-plane slow axis direction) of the liquid crystal compound differs depending on the position of the optically anisotropic layer in a thickness direction.

In addition, the homogeneous alignment refers to a state in which a molecular axis of a liquid crystal compound (for example, a major axis in a case of a rod-like liquid crystal compound) is disposed horizontally and in the same direction with respect to the layer surface (optical uniaxiality).

Here, “horizontal” does not require that the molecular axis of the liquid crystal compound is strictly horizontal with respect to the layer surface, but is intended to mean an alignment in which the tilt angle formed by the average molecular axis of the liquid crystal compound and the main surface of the layer is less than 20°.

In addition, the same direction does not require that the molecular axis of the liquid crystal compound is disposed strictly in the same direction with respect to the layer surface, but is intended to mean that, in a case where the direction of the in-plane slow axis is measured at any 20 positions in the plane, the maximum difference between the in-plane slow axis directions among the in-plane slow axis directions at 20 positions (the difference between the two in-plane slow axis directions having a maximum difference among the 20 in-plane slow axis directions) is less than 10°.

In a case where the optically anisotropic layer is a layer formed by fixing a liquid crystal compound twist-aligned along a helical axis extending in a thickness direction, the twisted angle of the liquid crystal compound (twisted angle in the alignment direction of the liquid crystal compound) is not particularly limited and is often more than 0° and 360° or less. From the viewpoint of excellent antireflection performance, the twisted angle of the liquid crystal compound is preferably 15° to 140° and more preferably 60° to 91° or 20° to 60°. Further, from the viewpoint that cracks are less likely to occur, the twisted angle of the liquid crystal compound is still more preferably 60° to 91°.

The twisted angle is measured using an AxoScan (polarimeter) device manufactured by Axometrics, Inc. and using device analysis software of Axometrics, Inc.

The value of a product Δnd of a refractive index anisotropy Δn of the optically anisotropic layer measured at a wavelength of 550 nm and a thickness d of the optically anisotropic layer is not particularly limited, and is preferably 100 to 380 am and more preferably 142 to 202 nm or 317 to 377 nm from the viewpoint that the effect of the present invention is more excellent.

The refractive index anisotropy Δn means the refractive index anisotropy of the optically anisotropic layer.

The Δnd is measured using an AxoScan (polarimeter) device manufactured by Axometrics, Inc. and using device analysis software of Axometrics, Inc.

Method for Producing Transfer Film

The method for producing the transfer film according to the embodiment of the present invention is not particularly limited, and is preferably a method of forming an optically anisotropic layer on a temporary support using a liquid crystal composition containing a liquid crystal compound.

More specifically, the method for producing the transfer film is preferably a method for producing a transfer film including a step 1 of applying a liquid crystal composition containing a liquid crystal compound having a polymerizable group onto a temporary support including a substrate to form a coating film, aligning the liquid crystal compound in the coating film, and subjecting the coating film to a curing treatment to form an optically anisotropic layer.

Hereinafter, the method using the liquid crystal composition will be described in detail.

The liquid crystal composition contains a liquid crystal compound having a polymerizable group (polymerizable liquid crystal compound). Examples of the liquid crystal compound include a rod-like liquid crystal compound and a disk-like liquid crystal compound as described above.

The content of the polymerizable liquid crystal compound in the liquid crystal composition is preferably 50% to 98% by mass and more preferably 70% to 95% by mass with respect to the total solid content of the composition.

The solid content means a component that can form an optically anisotropic layer, excluding a solvent, and even in a case where a component itself is in a liquid state, such a component is regarded as the solid content.

The liquid crystal composition may contain a component other than the polymerizable liquid crystal compound. The other component may be, for example, a polymerization initiator. The polymerization initiator used is selected according to the type of polymerization reaction, and examples thereof include a thermal polymerization initiator and a photopolymerization initiator.

The content of the polymerization initiator in the liquid crystal composition is preferably 0.01% to 20% by mass and more preferably 0.5% to 10% by mass with respect to the total solid content of the composition.

The liquid crystal composition may contain a polyfunctional compound other than the polymerizable liquid crystal compound.

The content of the polyfunctional compound in the liquid crystal composition is preferably 0.1% to 10.0% by mass and more preferably 0.2% to 5.0% by mass with respect to the total mass of the liquid crystal compound.

Examples of other components that may be contained in the liquid crystal composition include an alignment control agent (a vertical alignment agent and a horizontal alignment agent), a surfactant, an adhesion improver, a plasticizer, and a solvent, in addition to the foregoing components.

The liquid crystal composition preferably contains a chiral agent in order to twist-align a liquid crystal compound. The chiral agent is added to twist-align a liquid crystal compound, but of course, it is not necessary to add the chiral agent in a case where the liquid crystal compound is a compound exhibiting an optical activity such as having an asymmetric carbon in a molecule thereof. In addition, it is not necessary to add the chiral agent, depending on the production method and the twisted angle.

The chiral agent is not particularly limited in a structure thereof as long as it is compatible with the liquid crystal compound used in combination. Any known chiral agent (for example, described in “Liquid Crystal Device Handbook” edited by the 142nd Committee of the Japan Society for the Promotion of Science, Chapter 3, 4-3, Chiral agents for TN and STN, p. 199, 1989) can be used.

The amount of the chiral agent used is not particularly limited and is adjusted such that the above-mentioned twisted angle is achieved.

Examples of the method of applying the liquid crystal composition include a curtain coating method, a dip coating method, a spin coating method, a printing coating method, a spray coating method, a slot coating method, a roll coating method, a slide coating method, a blade coating method, a gravure coating method, and a wire bar method.

Next, the formed coating film is subjected to an alignment treatment to align a polymerizable liquid crystal compound in the coating film.

The alignment treatment can be carried out by drying the coating film at room temperature or by heating the coating film. In a case of a thermotropic liquid crystal compound, the liquid crystal phase formed by the alignment treatment can generally be transferred by a change in temperature or pressure.

The conditions in a case of heating the coating film are not particularly limited, and the heating temperature is preferably 50° C. to 250° C. and more preferably 50° C. to 150° C., and the heating time is preferably 10 seconds to 10 minutes.

In addition, after the coating film is heated, the coating film may be cooled, if necessary, before a curing treatment (light irradiation treatment) which will be described later.

Next, the coating film in which the polymerizable liquid crystal compound is aligned is subjected to a curing treatment.

The method of the curing treatment carried out on the coating film in which the polymerizable liquid crystal compound is aligned is not particularly limited, and examples thereof include a light irradiation treatment and a heat treatment. Above all, from the viewpoint of manufacturing suitability, a light irradiation treatment is preferable, and an ultraviolet irradiation treatment is more preferable.

The irradiation conditions of the light irradiation treatment are not particularly limited, and an irradiation amount of 50 to 1,000 mJ/cm² is preferable.

The atmosphere during the light irradiation treatment is not particularly limited and is preferably a nitrogen atmosphere.

One suitable aspect of the method for producing a transfer film may be, for example, a method using a temporary support having a dimensional change rate X in a predetermined range.

More specifically, the method for producing a transfer film may be, for example, a method using a temporary support in which, in a case where the optically anisotropic layer obtained by peeling the temporary support from the obtained transfer film is allowed to stand for 8 days in an environment with a temperature of 25° C. and a relative humidity of 60%, and then a direction in which a dimensional change rate in an in-plane direction of the optically anisotropic layer is the largest is defined as a direction X, the dimensional change rate X of the temporary support in the direction X calculated by the following method X for the temporary support in the transfer film is −0.25% or less. Method X: a dimension 1 of the temporary support in the direction X after allowing the temporary support to stand for 2 hours in an environment with a temperature of 25° C. and a relative humidity of 60%, and a dimension 2 of the temporary support in the direction X after allowing the temporary support to stand for 24 hours in an environment with a temperature of 80° C. and a relative humidity of less than 5% and further allowing the temporary support to stand for 2 hours in an environment with a temperature of 25° C. and a relative humidity of 60% are measured, and the dimensional change rate X calculated from Expression (3) is calculated.

Dimensional change rate X={(dimension 2−dimension 1)/dimension 1}×100 Expression (3)

Hereinafter, the temporary support will be described in detail.

In the following, first, the method of calculating the dimensional change rate X will be described in detail.

First, a measurement sample having a length of 15 cm and a width of 15 cm is cut out from the transfer film. Next, the cut out measurement sample is allowed to stand for 2 hours in an environment with a temperature of 25° C. and a relative humidity of 60%. Then, a total of 36 straight lines with a length of 10 cm are drawn on the surface of the optically anisotropic layer of the measurement sample by tilting the sample by 5 degrees. The length of the straight line is measured by QVA606-PRO-AEL10 (manufactured by Mitutoyo Corporation).

Next, the temporary support is peeled off from the measurement sample, the obtained optically anisotropic layer is allowed to stand for 8 days in an environment with a temperature of 25° C. and a relative humidity of 60%, and then the lengths of 36 straight lines drawn on the surface of the optically anisotropic layer are measured using the above apparatus in an environment with a temperature of 25° C. and a relative humidity of 60%. The direction in which the straight line having the largest change from the initial value (10 cm) out of the measured values of the 36 straight lines extends is defined as the direction X having the largest dimensional change rate.

As described above, after specifying the direction X in the optically anisotropic layer, a strip-like (length: 12 cm, width: 3 cm) measurement sample having the direction X of the optically anisotropic layer in the transfer film as the longitudinal direction is newly cut out from the transfer film. That is, once the optically anisotropic layer is taken out from the transfer film, the direction X in the optically anisotropic layer is specified, and then the measurement sample extending in the direction X of the optically anisotropic layer in the transfer film is cut out from the transfer film. Therefore, in the cut out measurement sample, the longitudinal direction thereof corresponds to the direction X.

Next, the temporary support is peeled off from the cut out measurement sample, and two pin holes at intervals of 10 cm are provided along the longitudinal direction of the peeled temporary support. Then, the obtained temporary support is allowed to stand for 2 hours in an environment with a temperature of 25° C. and a relative humidity of 60%, and then the distance between the two pin holes is measured. The obtained value corresponds to the dimension 1 of the temporary support in the direction X after the temporary support is allowed to stand for 2 hours in an environment with a temperature of 25° C. and a relative humidity of 60%.

Next, the temporary support whose dimension 1 is measured is allowed to stand for 24 hours in an environment with a temperature of 80° C. and a relative humidity of less than 5% and is further allowed to stand for 2 hours in an environment with a temperature of 25° C. and a relative humidity of 60%, and then the distance between the two pin holes is measured. The obtained value corresponds to the dimension 2 of the temporary support in the direction X after the temporary support is allowed to stand for 24 hours in an environment with a temperature of 80° C. and a relative humidity of less than 5% and is further allowed to stand for 2 hours in an environment with a temperature of 25° C. and a relative humidity of 60%.

Using the obtained dimension 1 and dimension 2, the dimensional change rate X is calculated from Expression (3).

Dimensional change rate X={(dimension 2−dimension 1)/dimension 1}×100 Expression (3)

The dimensional change rate X is preferably −0.25% or less and more preferably −0.40% or less. The lower limit of the dimensional change rate X is not particularly limited, and is often −2.0% or more and more often −1.0% or more.

In a case where a transfer film is produced using the temporary support exhibiting the predetermined dimensional change rate X, the temporary support also tends to shrink in accordance with the curing shrinkage of an optically anisotropic layer in a case where the optically anisotropic layer is produced. As a result, it is easy to obtain an optically anisotropic layer satisfying the above-mentioned requirements of Expression (1) or Expression (2).

As another suitable aspect of the method for producing a transfer film, there is an aspect including a step 2 of bringing the optically anisotropic layer into contact with superheated steam after the step 1.

The internal stress in the optically anisotropic layer is relaxed by carrying out the step 2, and therefore it is easy to obtain an optically anisotropic layer satisfying the above-mentioned requirements of Expression (1) or Expression (2).

The temperature of the superheated steam is not particularly limited, and is preferably 110° C. or higher at 1 atm and more preferably 115° C. or higher at 1 atm. The upper limit of the temperature of the superheated steam is preferably 180° C. or lower at 1 atm and more preferably 160° C. or lower at 1 atm from the viewpoint of the heat resistant temperature of the substrate.

The contact time between the optically anisotropic layer and the superheated steam is not particularly limited, and is preferably 20 to 120 seconds and more preferably 40 to 90 seconds from the viewpoint that the effect of the present invention is more excellent.

Uses

The transfer film according to the embodiment of the present invention can be applied to various uses.

For example, the transfer film according to the embodiment of the present invention can be applied to the production of a polarizing plate. For example, the polarizing plate can be produced in such a manner that a laminate including a polarizer and a transfer film are bonded to each other such that the laminate and an optically anisotropic layer face each other, and a temporary support is peeled off from the obtained laminate.

The polarizing plate is preferably a circularly polarizing plate. The circularly polarizing plate is an optical element that converts unpolarized light into circularly polarized light.

Hereinafter, the polarizing plate will be described in detail.

The polarizing plate obtained by the above procedure includes an optically anisotropic layer contained in the above-mentioned transfer film and a polarizer.

The optically anisotropic layer is as described above.

The polarizer may be a member having a function of converting natural light into specific linearly polarized light, and examples thereof include an absorption type polarizer.

An iodine-based polarizer, a dye-based polarizer using a dichroic dye, a polyene-based polarizer, or the like is used as the absorption type polarizer. The iodine-based polarizer and the dye-based polarizer include a coating type polarizer and a stretching type polarizer, both of which can be applied.

In addition, examples of a method for obtaining a polarizer by stretching and dyeing a laminated film having a polyvinyl alcohol layer formed on a substrate include the methods described in JP5048120B, JP5143918B, JP4691205B, JP4751481B, and JP4751486B. Known techniques for these polarizers can also be preferably used.

Examples of the reflective type polarizer include a polarizer in which thin films having different birefringences are laminated, a wire grid polarizer, and a polarizer in which a cholesteric liquid crystal having a selective reflection range and a ¼ wavelength plate are combined.

Above all, from the viewpoint of more excellent adhesiveness, a polarizer containing a polyvinyl alcohol-based resin (a polymer containing —CH₂—CHOH— as a repeating unit; in particular, at least one selected from the group consisting of a polyvinyl alcohol and an ethylene-vinyl alcohol copolymer) is preferable.

A protective film may be disposed on one side or both sides of the polarizer. That is, a polarizer with a protective film may be used.

Examples of the protective film include known resin films.

The thickness of the polarizer is not particularly limited, and is preferably 3 to 60 μm and more preferably 5 to 30 μm.

The polarizing plate may include another member other than the above-mentioned optically anisotropic layer and polarizer.

The other member may include another optically anisotropic layer other than the above-mentioned optically anisotropic layer.

The other optically anisotropic layer is preferably an optically anisotropic layer having characteristics that the laminate obtained in combination with the above-mentioned optically anisotropic layer can function as a λ/4 plate.

The λ/4 plate is a plate having a function of converting linearly polarized light having a specific wavelength into circularly polarized light (or converting circularly polarized light into linearly polarized light). More specifically, the λ/4 plate is a plate in which the in-plane retardation Re at a predetermined wavelength λ nm is λ/4 (or an odd multiple thereof).

The in-plane retardation (Re(550)) of the λ/4 plate at a wavelength of 550 nm may have an error of about 25 nm centered on an ideal value (137.5 nm), and is, for example, preferably 110 to 160 nm and more preferably 120 to 150 nm.

The in-plane retardation of the other optically anisotropic layer at a wavelength of 550 nm is not particularly limited, and is preferably 142 to 202 nm.

The other optically anisotropic layer is preferably an A-plate.

There are two types of A-plates, a positive A-plate (A-plate which is positive) and a negative A-plate (A-plate which is negative). The positive A-plate satisfies the relationship of Expression (A1) and the negative A-plate satisfies the relationship of Expression (A2) in a case where a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. In addition, the positive A-plate has an Rth showing a positive value and the negative A-plate has an Rth showing a negative value.

nx>ny≈nz Expression (A1)

ny<nx≈nz Expression (A2)

It should be noted that the symbol “≈” encompasses not only a case where the both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

The polarizing plate may have an adhesion layer between the optically anisotropic layer and the polarizer.

Examples of the adhesion layer include the above-mentioned known pressure sensitive adhesive layers and adhesive layers.

The method for producing a polarizing plate is preferably a method in which a laminate including a polarizer and a transfer film are bonded to each other such that the laminate and an optically anisotropic layer face each other, and a temporary support is peeled off from the obtained laminate to produce a polarizing plate, as described above.

In addition, the above-mentioned other members (the other optically anisotropic layer and the adhesion layer) may be included in the laminate including a polarizer.

In addition, in a case where the laminate and the transfer film are bonded to each other, these members may be laminated through an adhesion layer.

Image Display Apparatus

The optically anisotropic layer contained in the transfer film according to the embodiment of the present invention and the above-mentioned polarizing plate can be suitably applied to an image display apparatus.

The image display apparatus according to the embodiment of the present invention has an image display element and the above-mentioned optically anisotropic layer or polarizing plate.

The image display element is not particularly limited, and examples thereof include an organic electroluminescence display element and a liquid crystal display element.

### EXAMPLES

Hereinafter, features of the present invention will be described more specifically with reference to Examples and Comparative Examples. The materials, amounts used, proportions, treatment details, treatment procedure, and the like shown in the following Examples can be appropriately changed without departing from the spirit and scope of the present invention. Accordingly, the scope of the present invention should not be construed as being limited by the specific examples given below.

### Preparation of Substrate

### Preparation of Substrate 1

The following components are put into a mixing tank, stirred, heated at 90° C. for 10 minutes, and then filtered through a filter paper having an average pore diameter of 34 μm and a sintered metal filter having an average pore diameter of 10 μm to produce a cellulose acylate dope (hereinafter, also simply referred to as “dope”). The concentration of solid contents of the obtained dope was 23.5% by mass, and the mass ratio of the solvent was methylene chloride/methanol/butanol=81/18/1.

Cellulose acylate dope

| | | |
|---|---|---|
| Cellulose acylate | 100 | parts by mass |
| (acetyl substitution degree: 2.86, viscosity average | | |
| polymerization degree: 310) | | |
| Sugar ester compound 1 (shown in Chemical Formula (S4)) | 6.0 | parts by mass |
| Sugar ester compound 2 (shown in Chemical Formula (S5)) | 2.0 | parts by mass |
| Silica particle dispersion | 0.1 | parts by mass |

| | |
|---|---|
| (AEROSIL R972, manufactured by Nippon Aerosil Co., Ltd.) | |
| Solvent (methylene chloride/methanol/butanol) | a predetermined amount |

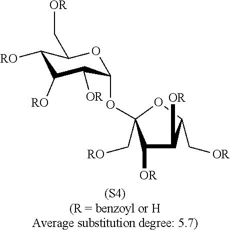

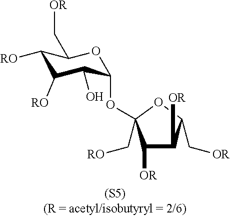

The above-mentioned dope was cast using a drum film forming machine. The above-mentioned dope for forming a core layer so as to be in contact with a metal substrate cooled to 0° C. and the above-mentioned dope for forming a surface layer on the core layer were co-cast from a die, and then the obtained film was peeled off. The drum was made of Steel Use Stainless (SUS).

Using a tenter device that clips both ends of a film with clips to transport the film, the film peeled off from the drum was dried at 30° C. to 40° C. for 20 minutes during transport. Next, the obtained film was post-dried by zone heating while being rolled and transported. Then, the obtained film was knurled and then wound up.

The obtained elongated cellulose acylate film had a film thickness of 40 μm, an in-plane retardation Re(550) of 1 nm at a wavelength of 550 nm, and a thickness direction retardation Rth(550) of 26 nm at a wavelength of 550 nm.

### Preparation of Substrate 2

90 parts by mass of syndiotactic polystyrene (“130-ZC”, manufactured by Idemitsu Kosan Co., Ltd., glass transition temperature: 98° C., crystallization temperature: 140° C.) and 10 parts by mass of poly(2,6-dimethyl-1,4-phenylene oxide) (Catalog No. 18242-7, manufactured by Sigma-Aldrich Co. LLC.) were kneaded with a twin screw extruder to obtain pellets of a transparent resin R2. The glass transition temperature of the obtained resin R2 was 105° C. The pellets of the resin R2 were supplied to a twin screw extruder and melt-extruded into a sheet at about 280° C. to obtain a resin sheet having a thickness of 80 μm. This unstretched sheet was stretched 1.5 times in length and 1.8 times in width under a temperature condition of 140° C. to obtain a substrate 2 (thickness: 40 μm).

### Preparation of Substrate 3

After passing the substrate 1 through a dielectric heating roll at a temperature of 60° C. to raise the film surface temperature to 40° C., an alkaline solution having the following composition was applied to one side of the film at a coating amount of 14 ml/m² using a bar coater, followed by heating to 110° C.

Next, the obtained film was transported under a steam-type far-infrared heater manufactured by Noritake Co., Limited for 10 seconds.

Then, pure water was applied to the obtained film at 3 ml/m² using the same bar coater.

Next, the obtained film was washed with water by a fountain coater and drained by an air knife three times, and then transported to a drying zone at 70° C. for 10 seconds and dried to obtain a substrate 3 which is a cellulose acylate film subjected to an alkali saponification treatment.

Alkaline solution

| | | |
|---|---|---|
| Potassium hydroxide | 4.7 | parts by mass |
| Water | 15.8 | parts by mass |
| Isopropanol | 63.7 | parts by mass |
| Surfactant (C₁₄H₂₉O(CH₂CH₂O)₂₀H) | 1.0 | parts by mass |
| Propylene glycol | 14.8 | parts by mass |

### Preparation of Substrate 4

The substrate 4 was prepared in the same manner as the substrate 1, except that the cellulose acylate used for producing the substrate 1 had an acetyl substitution degree of 2.5 and the dried film was stretched by 30% at 185° C.

The obtained elongated cellulose acylate film had a film thickness of 40 un, an in-plane retardation Re (550) of 45 nm at a wavelength of 550 nm, and a thickness direction retardation Rth (550) of 100 nm at a wavelength of 550 nm.

### Preparation of Temporary Support

### Preparation of Temporary Support 1

The following composition for forming a photo-alignment film was continuously applied onto one surface of the prepared substrate 1 with a bar coater. After the application of the composition, the obtained substrate 1 was dried in a heating zone at 120° C. for 1 minute to remove the solvent to form a coating film having a thickness of 0.3 μm. Subsequently, while winding the obtained substrate 1 around a mirror-finished back-up roll, a photo-alignment film was formed by irradiation with polarized ultraviolet rays (10 mJ/cm², using an ultra-high pressure mercury lamp) so as to have the in-plane slow axis of the optically anisotropic layer of each of Examples of Table 1 which will be described later, whereby a temporary support 1 was prepared.

Here, the longitudinal direction and the transport direction of the elongated film are parallel to each other, and the counterclockwise direction is represented by a positive value with the transport direction of the cellulose acylate film as a reference (0°) in a case of being observed from the coated surface side.

Composition for forming photo-alignment film

| | | |
|---|---|---|
| Polymer Ap1 given below | 10 | parts by mass |
| NOMCORT TAB given below | 1.52 | parts by mass |
| (manufactured by | | |
| The Nisshin OilliO Group, Ltd.) | | |
| Polyfunctional epoxy compound | 12.2 | parts by mass |
| (EPOLEAD GT401, manufactured by | | |
| Daicel Corporation) | | |
| Thermal acid generator | 0.55 | parts by mass |
| (SAN AID SI-60, manufactured by | | |
| Sanshin Chemical Industry Co., Ltd.) | | |
| Butyl acetate | 300 | parts by mass |

### Synthesis of Polymer Ap1

A monomer m−1 shown below was synthesized using 2-hydroxyethyl methacrylate (HEMA) (reagent available from Tokyo Chemical Industry Co., Ltd.) and the following cinnamic chloride derivative, according to the method described in Langmuir, 32 (36), 9245-9253 (2016).

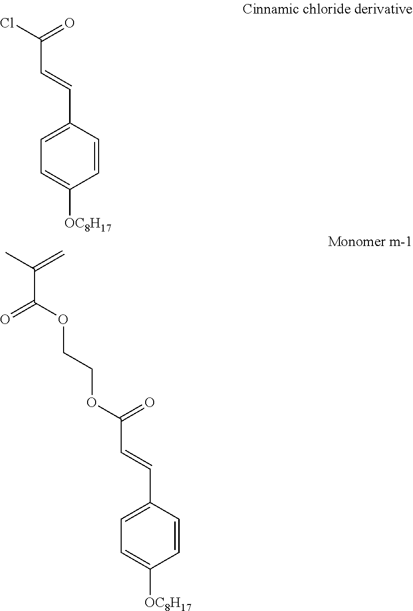

2-butanone (5 parts by mass) as a solvent was charged into a flask equipped with a cooling tube, a thermometer, and a stirrer, and refluxed by heating in a water bath while flowing nitrogen in the flask at 5 mL/min. A solution prepared by mixing the monomer m−1 (5 parts by mass), 3,4-epoxycyclohexylmethylmethacrylate (CYCLOMER M100, manufactured by Daicel Corporation) (5 parts by mass), 2,2′-azobis(isobutyronitrile) (1 part by mass) as a polymerization initiator, and 2-butanone (5 parts by mass) as a solvent was added dropwise thereto over 3 hours, followed by stirring for another 3 hours while maintaining a reflux state. After completion of the reaction, the reaction mixture was allowed to cool to room temperature and diluted by adding 2-butanone (30 parts by mass) to obtain about 20% by mass of a polymer solution. The obtained polymer solution was put into a large excess of methanol to precipitate the polymer, and the recovered precipitate was filtered off, washed with a large amount of methanol, and then air-blast dried at 50° C. for 12 hours to obtain a polymer Ap1 having a photo-aligned group.

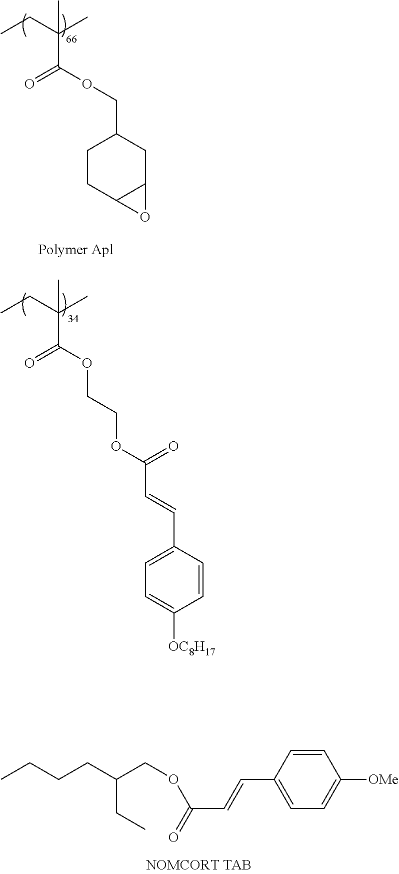

### Preparation of Temporary Support 2

The temporary support 2 was prepared in the same manner as in the section of (Preparation of temporary support 1), except that the substrate 2 was used instead of the substrate 1.

### Preparation of Temporary Support 3

The composition for forming an alignment film having the following composition was continuously applied onto the substrate 3 with a #14 wire bar. After the application of the composition, the coating film was dried with hot air at 60° C. for 60 seconds and further with hot air at 100° C. for 120 seconds. In the following composition, “Polymerization initiator (IN1)” represents a photopolymerization initiator (IRGACURE 2959, manufactured by BASF SE).

Next, the dried coating film was continuously subjected to a rubbing treatment to form an alignment film, whereby a temporary support 3 was prepared.

At this time, the rubbing treatment was carried out so as to have the in-plane slow axis of the optically anisotropic layer shown in Example 5 of Table 1 which will be described later.

Composition for forming alignment film

| | | |
|---|---|---|
| Modified polyvinyl alcohol given below | 10 | parts by mass |
| Water | 371 | parts by mass |
| Methanol | 119 | parts by mass |
| Glutaraldehyde | 0.5 | parts by mass |
| Polymerization initiator (IN1) | 0.3 | parts by mass |

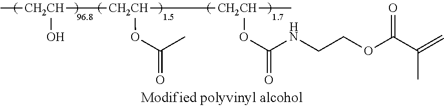

### Example 1

A composition for forming an optically anisotropic layer was applied onto the photo-alignment film of the temporary support 1 using a geeser coating machine, and the film on which a composition layer was formed was heated at 90° C. for 80 seconds.

Then, the composition layer was irradiated (irradiation amount: 500 mJ/cm²) with light from a metal halide lamp (manufactured by Eye Graphics Co., Ltd.) at 55° C. in a nitrogen atmosphere to form an optically anisotropic layer 1 having a fixed alignment of the liquid crystal compound to prepare a transfer film 1. The thickness of the optically anisotropic layer was 1.4 μm.

Composition of composition (A) for forming optically anisotropic layer

| | | |
|---|---|---|
| Rod-like liquid crystal compound (A) given below | 80 | parts by mass |
| Rod-like liquid crystal compound (B) given below | 10 | parts by mass |
| Rod-like liquid crystal compound (C) given below | 10 | parts by mass |
| Ethylene oxide-modified trimethylolpropane triacrylate | 4 | parts by mass |
| (V# 360. manufactured by Osaka Organic Chemical Industry Ltd.) | | |
| Photopolymerization initiator | 3 | parts by mass |
| (IRGACURE 819, manufactured by BASF Japan Ltd.) | | |
| Chiral agent (A.) given below | 0.30 | parts by mass |
| Polymer (A) given below | 0.08 | parts by mass |
| Methyl isobutyl ketone | 117 | parts by mass |
| Ethyl propionate | 39 | parts by mass |
| Rod-like liquid crystal compound (A) (hereinafter, corresponding to a mixture | | |
| of liquid crystal compounds) | | |

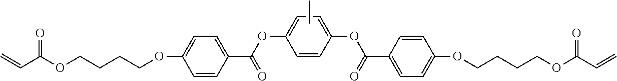

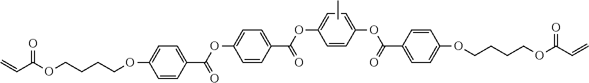

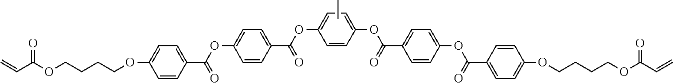

Rod-like liquid crystal compound (B) 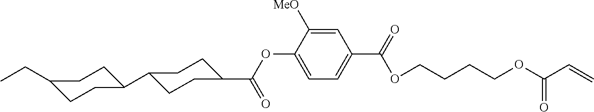 [SMILES: C=CC(=O)OCCCCOC(=O)c1ccc(OC(=O)C2CCC(C3CCC(CC)CC3)CC2)c(OC)c1]
Rod-like liquid crystal compound (C) 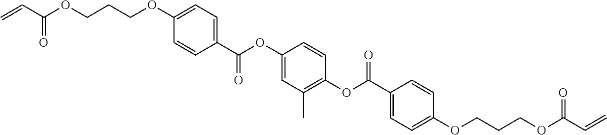 [SMILES: C=CC(=O)OCCCOc1ccc(C(=O)Oc2ccc(OC(=O)c3ccc(OCCCOC(=O)C=C)cc3)c(C)c2)cc1]
Chiral agent (A)

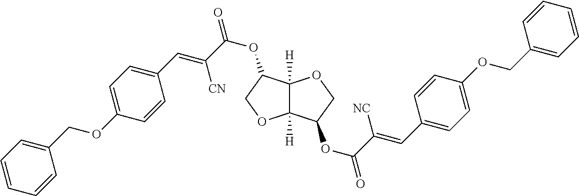

Polymer (A) (In the formula, the numerical value described in each repeating unit represents the content (% by mass) of each repeating unit with respect to all the repeating units).

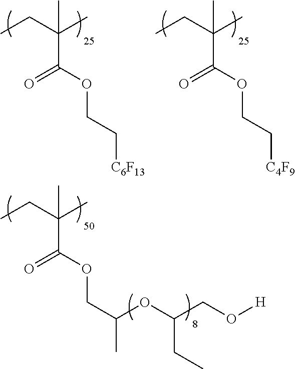

### Examples 2 to 5 and Comparative Example 1

A transfer film was prepared in the same manner as in Example 1, except that the type of temporary support used, the thickness of the optically anisotropic layer, the type of chiral agent, the content of the chiral agent, And, the axis direction, the twisted angle, the alignment direction, and the like were changed as shown in Table 1 which will be described later.

The following compound was used as the chiral agent (B).

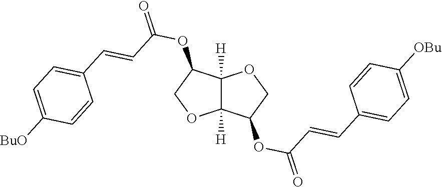

### Example 6

An optically anisotropic layer was prepared in the same manner as in Comparative Example 1.

Next, a superheated steam treatment was carried out by transporting the film in a tank maintained at a temperature of 120° C. and a steam density of 300 g/m³ for 60 seconds to obtain a transfer film of Example 6.

Evaluation

Measurement of dimensional change in in-plane direction of optically anisotropic layer after peeling of temporary support

A measurement sample having a length of 15 cm and a width of 15 cm was cut out from the transfer film prepared in each of Examples and Comparative Examples. Next, the cut out measurement sample was allowed to stand for 2 hours in an environment with a temperature of 25° C. and a relative humidity of 60%. Then, a total of 36 straight lines with a length of 10 cm were drawn on the surface of the optically anisotropic layer of the measurement sample by tilting the sample by 5 degrees. The length of the straight line was measured by QVA606-PRO-AEL10 (manufactured by Mitutoyo Corporation).

Next, the temporary support was peeled off from the measurement sample, the obtained optically anisotropic layer was allowed to stand for 8 days in an environment with a temperature of 25° C. and a relative humidity of 60%, and then the lengths of 36 straight lines drawn on the surface of the optically anisotropic layer were measured using the above apparatus in an environment with a temperature of 25° C. and a relative humidity of 60%. ΔL (max) (%) was calculated according to Expression A using a length L max (cm) of the straight line having the largest change from an initial value (10 cm) among the measured values of the 36 straight lines.

ΔL (max)={(absolute value of difference between L max and 10 cm)/10}×100 Expression A

Next, ΔL (min)(%) was calculated according to Expression B using a length L min (cm) of the straight line having the smallest change from the initial value (10 cm) among the measured values of the 36 straight lines.

ΔL (min)={(absolute value of difference between L min and 10 cm)/10}×100 Expression B

Measurement of Defect Frequency of Transfer Film

The transfer film (observation area: 1.5 m²) prepared in each of Examples and Comparative Examples was observed with Schaukasten (display case), and the number of point defects having a diameter of 50 μm or more was counted.

A: The number of point defects having a diameter of 50 μm or more is 1 or less

B: The number of point defects having a diameter of 50 μm or more is more than 1 and 3 or less

C: The number of point defects having a diameter of 50 μm or more is more than 3 and 5 or less

D: The number of point defects having a diameter of 50 μm or more is more than 5

Measurement of Defect Frequency of Image Display Apparatus

The section of (Measurement of defect frequency of transfer film) was carried out on the transfer film prepared in each of Examples and Comparative Examples, and in a case where the evaluations were A to C, the following treatment was carried out. In this regard, although the evaluation was D for Comparative Example 1, the following treatment was carried out.

A cellulose triacetate substrate (FUJITAC) and a polarizer (including polyvinyl alcohol) were bonded to each other, and each of polymer films 1 to 4 which will be described later, as shown in Table 2 and the optically anisotropic layer in the transfer film of each of Examples and Comparative Examples were transferred on the side of the obtained laminate opposite to the cellulose triacetate substrate side to prepare a circularly polarizing plate having each layer shown in Table 2. In addition, each layer was disposed in the order of the first layer to the third layer shown in Table 2.

In a case of transferring the optically anisotropic layer in the transfer film, the optically anisotropic layer and the bonded body were closely attached to each other through a pressure sensitive adhesive (manufactured by Lintec Corporation), and the temporary support was peeled off. In addition, the transfer film and the polarizer were bonded such that the longitudinal direction of the transfer film and the absorption axis of the polarizer were parallel to each other.

In addition, the polymer film was also bonded through a pressure sensitive adhesive (manufactured by Lintec Corporation). In a case of producing the circularly polarizing plate, the polymer film was bonded so as to have an axial relationship as shown in Table 2 which will be described later.

The polymer films 1 to 4 were produced by the method which will be described later, and the in-plane retardation and the in-plane slow axis direction of each of the polymer films 1 to 4 at a wavelength of 550 nm were adjusted as shown in Table 2 such that the portion composed of each of the polymer films 1 to 4 and the optically anisotropic layer in the circularly polarizing plate functions as a λ/4 plate.

The OLED55B8PJA (manufactured by LG Electronics Co., Ltd.) equipped with an organic EL panel (organic EL display element) was disassembled, and a touch panel with a circularly polarizing plate was peeled off from the organic EL display device. Two organic EL display devices in which the circularly polarizing plate prepared above was bonded so as not to allow air to enter were prepared, and the number of point defects having a diameter of 50 μm or more in a case of being observed with external light was counted. There is no problem in practical use for evaluations of A to C.

A: The number of point defects having a diameter of 50 μm or more is 1 or less

B: The number of point defects having a diameter of 50 μm or more is more than 1 and 3 or less

C: The number of point defects having a diameter of 50 μm or more is more than 3 and 5 or less

D: The number of point defects having a diameter of 50 μm or more is more than 5

### Preparation of Polymer Film 1

Pellets of thermoplastic norbornene resin (trade name “ZEONOR 1420R”, manufactured by Zeon Corporation) were dried at 90° C. for 5 hours. The dried pellets were supplied to an extruder, melted in the extruder, passed through a polymer pipe and a polymer filter, and extruded into a sheet from the T-die onto the casting drum, and the extruded sheet was cooled and wound to obtain a roll of a pre-stretched substrate having a width of 1490 mm.

The obtained pre-stretched substrate was pulled out from the roll, supplied to a tenter stretching machine, and stretched such that the alignment angle of the film was in a predetermined direction. Further, both ends in the width direction of the film were trimmed and the film was wound to obtain a roll of an elongated stretched substrate having a width of 1350 mm.

As described above, the in-plane retardation and the in-plane slow axis direction of the stretched substrate at a wavelength of 550 nm were respectively 180 nm and 10° so as to constitute λ/4 plate together with the optically anisotropic layer used.

The polymer films 2 to 4 were prepared by the same preparation method as that of the polymer film 1, except that the thickness and the stretching direction of the polymer film 1 were adjusted so as to have the optical properties shown in Table 2.

In a case where the same measurement as the section of (Measurement of defect frequency of transfer film) was carried out using the polymer films 1 to 4, no point defects were observed.

In addition, in a case where the same measurement as the section of (Measurement of defect frequency of image display apparatus) was carried out using the polymer films 1 to 4 instead of the circularly polarizing plate, no point defects were observed.

As described above, no point defects were observed in the polymer films 1 to 4.

Measurement of Dimensional Change Rate X of Temporary Support

First, a measurement sample having a length of 15 cm and a width of 15 cm was cut out from the transfer film. Next, the cut out measurement sample was allowed to stand for 2 hours in an environment with a temperature of 25° C. and a relative humidity of 60%. Then, a total of 36 straight lines with a length of 10 cm were drawn on the surface of the optically anisotropic layer of the measurement sample by tilting the sample by 5 degrees. The length of the straight line is measured by QVA606-PRO-AEL10 (manufactured by Mitutoyo Corporation).

Next, the temporary support was peeled off from the measurement sample, the obtained optically anisotropic layer was allowed to stand for 8 days in an environment with a temperature of 25° C. and a relative humidity of 60%, and then the lengths of 36 straight lines drawn on the surface of the optically anisotropic layer were measured using the above apparatus in an environment with a temperature of 25° C. and a relative humidity of 60%. The direction in which the straight line having the largest change from the initial value (10 cm) out of the measured values of the 36 straight lines extends was defined as the direction X having the largest dimensional change rate.

Next, a strip-like (length: 12 cm, width: 3 cm) measurement sample having the direction X of the optically anisotropic layer in the transfer film as the longitudinal direction was newly cut out from the transfer film.

Next, the temporary support was peeled off from the cut out measurement sample, and two pin holes at intervals of 10 cm were provided along the longitudinal direction of the peeled temporary support. Then, the obtained temporary support was allowed to stand for 2 hours in an environment with a temperature of 25° C. and a relative humidity of 60%, and then the distance between the two pin holes was measured. The obtained value corresponds to the dimension 1 of the temporary support in the direction X after the temporary support is allowed to stand for 2 hours in an environment with a temperature of 25° C. and a relative humidity of 60%.

Next, the temporary support whose dimension 1 was measured was allowed to stand for 24 hours in an environment with a temperature of 80° C. and a relative humidity of less than 5% and was further allowed to stand for 2 hours in an environment with a temperature of 25° C. and a relative humidity of 60%, and then the distance between the two pin holes was measured. The obtained value corresponds to the dimension 2 of the temporary support in the direction X after the temporary support is allowed to stand for 24 hours in an environment with a temperature of 80° C. and a relative humidity of less than 5% and is further allowed to stand for 2 hours in an environment with a temperature of 25° C. and a relative humidity of 60%.

Using the obtained dimension 1 and dimension 2, the dimensional change rate X was calculated from Expression (3).

Dimensional change rate X={(dimension 2−dimension 1)/dimension 1}×100 Expression (3)

Evaluation of Crackability

Each transfer film was cut out to a size of 100 mm×100 mm, a pressure sensitive adhesive (“SK2057”, manufactured by Soken Chemical & Engineering Co., Ltd.) was bonded to the surface of the obtained sample on the optically anisotropic layer side, the sample was attached to a glass plate through the adhesive, and then the temporary support was peeled off. The above operation was carried out four times to prepare four sets of laminates of an optically anisotropic layer and a glass plate.

A cycle test (Hitachi environmental test equipment ES207LH) of storing the obtained laminate for 1 hour under the condition of temperature −35° C. and then storing the obtained laminate for 1 hour under the condition of temperature 70° C. was carried out for 50 cycles. The appearance of the four sets of laminates after the cycle test was observed with a microscope, and cracks were evaluated according to the following standards. It is practically preferable that the evaluation is A or B, and it is preferable that the evaluation is A.

“A”: No fissuring was observed in any of optically anisotropic layers.

“B”: Fissuring was observed only in one set of optically anisotropic layers.

“C”: Fissuring was observed in two or more sets of optically anisotropic layers.

In Table 1, the column of “Re(nm)” in the column of “Temporary support” represents the in-plane retardation (nm) of each of the substrates 1 to 4 in the temporary support at a wavelength of 550 nm.

In Table 1, the column of “Tg (° C.)” in the column of “Temporary support” represents the glass transition temperature (° C.) of each of the substrates 1 to 4 in the temporary support.

In Table 1, the column of “Dimensional change rate X (%)” in the column of “Temporary support” represents the dimensional change rate X of the temporary support.

In Table 1, the column of “Amount of chiral agent (parts by mass)” in the column of “Optically anisotropic layer” represents the content (parts by mass) of the chiral agent (A) contained in the composition for forming an optically anisotropic layer.

In Table 1, the column of “And (nm)” in the column of “Optically anisotropic layer” represents the product Δnd (nm) of the refractive index anisotropy Δn of the optically anisotropic layer at a wavelength of 550 nm and the thickness d of the optically anisotropic layer.

In Table 1, the column of “Axis direction” in the column of “Optically anisotropic layer” represents the direction of the in-plane slow axis on the surface of the optically anisotropic layer on the temporary support side, and the counterclockwise direction is represented by a positive value with the longitudinal direction (transport direction) of the transfer film as a reference (0°) in a case of being observed from the optically anisotropic layer side.

In Table 1, in the column of “Twisted direction” in the column of “Optically anisotropic layer”, the case where the twisted direction is clockwise is expressed as “Clockwise”, and the case where the twisted direction is counterclockwise is expressed as “Counterclockwise” with reference to the in-plane slow axis on the surface (the surface on the air side) of the optically anisotropic layer opposite to the temporary support side in a case where the transfer film is observed from the optically anisotropic layer side.

In Table 1, the column of “Twisted angle (°)” in the column of “Optically anisotropic layer” represents the twisted angle (°) of the liquid crystal compound.

In Table 1, the column of “Superheated steam treatment” in the column of “Optically anisotropic layer” represents whether or not the superheated steam treatment (the step 2 described above) was carried out in a case where the optically anisotropic layer was produced. The case where the superheated steam treatment was carried out is described as “Applied”, and the case where the superheated steam treatment was not carried out is described as “Not applied”.

In Table 2, the column of “Angle (°) with respect to absorption axis of polarizer” represents the angle of the in-plane slow axis of the polymer film used in each Example with respect to the absorption axis of the polarizer. The above angle is expressed as a positive value in a counterclockwise direction with the absorption axis of the polarizer as a reference (0°) in a case where the circularly polarizing plate is observed from the polarizer side.

In Table 2, the column of “ΔL (max)” and the column of “ΔL (max)/ΔL (min)” show the results regarding the optically anisotropic layer used in each Example.

TABLE 1

| | | | | | Optically anisotropic layer | | | | | | | |
|---|---|---|---|---|---|---|---|---|---|---|---|---|
| | | | | | | | Amount | | | | | |
| | Temporary support | | | | | | of chiral | | | | | |
| | | | | Dimensional | Film | | agent | | direction | | Twisted | Superheated |
| | | Re | Tg | change rate | thickness | Chiral | (parts by | Δnd | Axis | | angle | steam |
| | Type | (nm) | (° C.) | X (%) | (μm) | agent | mass) | (nm) | (°) | Twisted direction | (°) | treatment |
| Example 1 | 1 | 1 | 179 | −0.08 | 1.4 | A | 0.3 | 180 | 85 | Clockwise | −75 | Not applied |
| Example 2 | 1 | 1 | 179 | −0.08 | 1.4 | B | 0.24 | 180 | 65 | Counterclockwise | 60 | Not applied |
| Example 3 | 1 | 1 | 179 | −0.08 | 2.7 | B | 0.08 | 347 | −40 | Counterclockwise | 40 | Not applied |
| Example 4 | 2 | 0 | 105 | −0.78 | 2.1 | — | 0 | 275 | 22.5 | — | 0 | Not applied |
| Example 5 | 3 | 1 | 179 | −0.09 | 2.7 | B | 0.08 | 347 | −40 | Counterclockwise | 40 | Not applied |
| Example 6 | 1 | 1 | 179 | −0.08 | 2.1 | — | 0 | 275 | 22.5 | — | 0 | Applied |
| Comparative | 1 | 3 | 179 | −0.08 | 2.1 | — | 0 | 275 | 22.5 | — | 0 | Not applied |
| Example 1 | | | | | | | | | | | | |
| Comparative | 4 | 45 | 179 | −0.08 | 2.7 | B | 0.08 | 347 | −40 | Counterclockwise | 40 | Not applied |
| Example 2 | | | | | | | | | | | | |

TABLE 2

| | | Second layer | | | Third layer | | | | | | | |
|---|---|---|---|---|---|---|---|---|---|---|---|---|
| | | | Angle with | | | Angle with | | Evaluation | | | | |
| | | | respect to | | | respect to | | | | | | Defects |
| | | | absorption | | | absorption | | | ΔL | Defects | | in |
| | First | | axis of | Re of | | axis of | Re of | | (max)/ | in | | image |
| | layer | | polarizer | polymer | | polarizer | polymer | | ΔL | transfer | | display |
| | Type | Type | (°) | film (nm) | Type | (°) | film (nm) | ΔL (max) | (min) | film | Cracks | avparatus |
| Example 1 | Polarizer | Polymer | 10 | 180 | Optically | | | 0.18% | 1 | A | A | A |
| | | Film 1 | | | anisotropic | | | | | | | |
| | | | | | layer of | | | | | | | |
| | | | | | Example 1 | | | | | | | |
| Example 2 | Polarizer | Optically | — | — | Polymer | −25° | 180 | 0.18% | 1.2 | A | A | A |
| | | anisotropic | | | Film 2 | | | | | | | |
| | | layer of | | | | | | | | | | |
| | | Example 2 | | | | | | | | | | |
| Example 3 | Polarizer | Optically | — | — | Polymer | 90° | 98 | 0.30% | 1.4 | B | B | B |
| | | anisotropic | | | Film 3 | | | | | | | |
| | | layer of | | | | | | | | | | |
| | | Example 3 | | | | | | | | | | |
| Example 4 | Polarizer | Optically | — | — | Polymer | 90° | 180 | 0.17% | 1 3 | B | B | B |
| | | anisotropic | | | Film 4 | | | | | | | |
| | | layer of | | | | | | | | | | |
| | | Example 4 | | | | | | | | | | |
| Example 5 | Polarizer | Optically | — | — | Polymer | 90° | 98 | 0.30% | 1.4 | C | B | C |
| | | anisotropic | | | Film 3 | | | | | | | |
| | | layer of | | | | | | | | | | |
| | | Example 5 | | | | | | | | | | |
| Example 6 | Polarizer | Optically | — | — | Polymer | 90° | 180 | 0.25% | 1.5 | B | B | B |
| | | anisotropic | | | Film 4 | | | | | | | |
| | | layer of | | | | | | | | | | |
| | | Example 6 | | | | | | | | | | |
| Com- | Polarizer | Optically | — | — | Polymer | 90° | 180 | 0.54% | 2.9 | D | C | D |
| parative | | anisotropic | | | Film 4 | | | | | | | |
| Example 1 | | layer | | | | | | | | | | |
| | | of Com- | | | | | | | | | | |
| | | parative | | | | | | | | | | |
| | | Example 1 | | | | | | | | | | |
| Com- | Polarizer | Optically | — | — | Polymer | 90° | 98 | 0.30% | 1.4 | B | B | D |
| parative | | anisotropic | | | Film 3 | | | | | | | |
| Example 2 | | layer | | | | | | | | | | |
| | | of Com- | | | | | | | | | | |
| | | parative | | | | | | | | | | |
| | | Example 2 | | | | | | | | | | |

### Example 5

As shown in Table 1 above, it was confirmed that a desired effect could be obtained by using the transfer film according to the embodiment of the present invention.

Above all, as shown in Examples 1 and 2, it was confirmed that the effect was more excellent in a case where ΔL (max)/ΔL (min) was 1.2 or less.

In addition, from the comparison between Example 5 and other Examples, it was confirmed that the effect was more excellent in a case where the photo-alignment film was used as the alignment film.

What is claimed is:

1. A transfer film comprising:
a temporary support including a substrate; and
an optically anisotropic layer disposed on the temporary support,
wherein an in-plane retardation of the substrate at a wavelength of 550 nm is 0 to 20 nm,
the optically anisotropic layer is a layer formed of a liquid crystal compound, and
in a case where the optically anisotropic layer obtained by peeling the temporary support from the transfer film is allowed to stand for 8 days in an environment with a temperature of 25° C. and a relative humidity of 60%, and then a maximum value of a dimensional change rate in an in-plane direction of the optically anisotropic layer is defined as ΔL (max) and a minimum value of the dimensional change rate is defined as ΔL (min), the transfer film satisfies at least one of Expression (1) or Expression (2),
ΔL (max)/ΔL(min)≤1.5, Expression (1)
ΔL(max)≤0.08%. Expression (2)

2. The transfer film according to claim 1,
wherein the temporary support further includes an alignment film.

3. The transfer film according to claim 1,
wherein the optically anisotropic layer is a layer formed by fixing a liquid crystal compound twist-aligned along a helical axis extending in a thickness direction, or a layer formed by fixing a liquid crystal compound aligned homogeneously.

4. The transfer film according to claim 1,
wherein the optically anisotropic layer is a layer formed by fixing a liquid crystal compound twist-aligned along a helical axis extending in a thickness direction, and
a twisted angle of the liquid crystal compound is 15° to 140°.

5. The transfer film according to claim 4,
wherein the twisted angle of the liquid crystal compound is 60° to 91°.

6. A method for producing a transfer film including a temporary support including a substrate and an optically anisotropic layer, the method comprising:
a step 1 of applying a liquid crystal composition containing a liquid crystal compound having a polymerizable group onto the temporary support to form a coating film, aligning the liquid crystal compound in the coating film, and subjecting the coating film to a curing treatment to form the optically anisotropic layer,
wherein, in a case where the optically anisotropic layer obtained by peeling the temporary support from the transfer film is allowed to stand for 8 days in an environment with a temperature of 25° C. and a relative humidity of 60%, and then a direction in which a dimensional change rate in an in-plane direction of the optically anisotropic layer is the largest is defined as a direction X, a dimensional change rate X of the temporary support in the direction X calculated by the following method X for the temporary support in the transfer film is −0.25% or less,
Method X: a dimension 1 of the temporary support in the direction X after allowing the temporary support to stand for 2 hours in an environment with a temperature of 25° C. and a relative humidity of 60%, and a dimension 2 of the temporary support in the direction X after allowing the temporary support to stand for 24 hours in an environment with a temperature of 80° C. and a relative humidity of less than 5% and further allowing the temporary support to stand for 2 hours in an environment with a temperature of 25° C. and a relative humidity of 60% are measured, and the dimensional change rate X is calculated from Expression (3),
Dimensional change rate X={(dimension 2−dimension 1)/dimension 1}×100. Expression (3)

7. A method for producing a transfer film, comprising:
a step 1 of applying a liquid crystal composition containing a liquid crystal compound having a polymerizable group onto a temporary support including a substrate to form a coating film, aligning the liquid crystal compound in the coating film, and subjecting the coating film to a curing treatment to form an optically anisotropic layer, and
a step 2 of bringing the optically anisotropic layer into contact with superheated steam after the step 1.

8. A polarizing plate comprising:
the optically anisotropic layer obtained by peeling the temporary support from the transfer film according to claim 1; and
a polarizer.

9. The polarizing plate according to claim 8,
wherein another optically anisotropic layer different from the optically anisotropic layer is further included between the optically anisotropic layer and the polarizer,
the optically anisotropic layer is a layer formed by fixing a liquid crystal compound twist-aligned along a helical axis extending in a thickness direction,
a twisted angle of the liquid crystal compound is 60° to 91°,
a product Δnd of a refractive index anisotropy Δn of the optically anisotropic layer at a wavelength of 550 nm and a thickness d of the optically anisotropic layer is 142 to 202 nm, and
an in-plane retardation of the other optically anisotropic layer at a wavelength of 550 nm is 142 to 202 nm.

10. An image display apparatus comprising:
the polarizing plate according to claim 8.

11. The transfer film according to claim 2,
wherein the optically anisotropic layer is a layer formed by fixing a liquid crystal compound twist-aligned along a helical axis extending in a thickness direction, or a layer formed by fixing a liquid crystal compound aligned homogeneously.

12. The transfer film according to claim 2,
wherein the optically anisotropic layer is a layer formed by fixing a liquid crystal compound twist-aligned along a helical axis extending in a thickness direction, and
a twisted angle of the liquid crystal compound is 15° to 140°.

13. The transfer film according to claim 3,
wherein the optically anisotropic layer is a layer formed by fixing a liquid crystal compound twist-aligned along a helical axis extending in a thickness direction, and
a twisted angle of the liquid crystal compound is 15° to 140°.

14. A polarizing plate comprising:
the optically anisotropic layer obtained by peeling the temporary support from the transfer film according to claim 2; and
a polarizer.

15. A polarizing plate comprising:
the optically anisotropic layer obtained by peeling the temporary support from the transfer film according to claim 3; and
a polarizer.

16. A polarizing plate comprising:
the optically anisotropic layer obtained by peeling the temporary support from the transfer film according to claim 4; and
a polarizer.

17. A polarizing plate comprising:
the optically anisotropic layer obtained by peeling the temporary support from the transfer film according to claim 5; and
a polarizer.

18. An image display apparatus comprising:
the polarizing plate according to claim 9.
